(19) United States
(12) Patent Application Publication
(10) Pub. No.: US 2026/0203035 A1
(43) Pub. Date: Jul. 16, 2026

(54) SOFTWARE STACK UPGRADES FOR A CONTAINER ORCHESTRATION SYSTEM

(71) Applicant: Dell Products, L.P., Round Rock, TX (US)

(72) Inventors: Mikhail Borisov, Dublin (IE); Vinod Gupta, Shrewsbury, MA (US); Mikhail Edkov, Ballincollig (IE)

(21) Appl. No.: 19/016,800

(22) Filed: Jan. 10, 2025

(51) Int. Cl. G06F 8/65; G06F 9/455

(52) U.S. Cl. CPC G06F 8/65; G06F 9/45558; G06F 2009/45575

(57) ABSTRACT

Seamless, full-stack upgrades in containerized environments (e.g., Kubernetes) with node-bound workloads are facilitated. Conventional upgrade approaches typically cause multiple restarts for each application container—once when upgrading the container itself, and again when upgrading the underlying node platform (operating system, firmware, and container orchestration). This repeated restart sequence extends the overall upgrade window and can compromise system performance and reliability. The disclosed technologies introduce an OnDrain upgrade strategy, which defers container upgrades until the node is explicitly drained as part of a platform-level upgrade. By synchronizing application-layer and platform-layer updates into a single node drain event, only one pod restart is used for each node-bound workload, drastically reducing system downtime.

### BACKGROUND

Containerization is a lightweight virtualization technique that provides high consistency, operating systems distribution portability, efficient resource management, and consistency across multiple environments. Thus, applications or application programming interfaces (APIs) can be containerized to provide numerous benefits to service providers and their subscribers. Due to the many benefits of containerization, many container orchestration (CO) systems and associated products have entered the marketplace to help automate and orchestrate containerization. One such example product is Kubernetes. Kubernetes is an open-sourced software tool that can effectively manage containerized applications with reduced manual intervention.

The CO system can be organized into various clusters, with each cluster having multiple nodes upon which containerized workloads (also referred to as applications or containerized applications) run. Each node can have a software stack, which includes software for the applications as well as infrastructure elements such as the CO system (e.g., Kubernetes) software itself, operating system software, and so on. Over time, this software stack is frequently updated.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a schematic block diagram illustrating an example container orchestration (CO) system having various elements that can be leveraged to upgrade a software stack of a node in accordance with certain embodiments of this disclosure;

FIG. 2 depicts schematic diagram illustrating a full software stack upgrade using previous strategies in accordance with certain embodiments of this disclosure;

FIG. 3 depicts a schematic block diagram illustrating an example CO system 300 comprising an OnDrain element that can be implemented to, e.g., defer the customer upgrade of applications until a drain operation is detected in accordance with certain embodiments of this disclosure;

FIG. 4 depicts an example call flow diagram illustrating an example call flow for a full software stack upgrade using the OnDrain strategy in accordance with certain embodiments of this disclosure;

FIG. 5 depicts a schematic diagram illustrating a full software stack upgrade that implements the OnDrain strategy in accordance with certain embodiments of this disclosure;

FIG. 6 depicts a schematic block diagram is depicted illustrating various examples of upgrade strategies that can be defined by the CO system in accordance with certain embodiments of this disclosure;

FIG. 7 depicts a schematic block diagram illustrating an example device that can implement an OnDrain upgrade strategy to defer application upgrades until a drain operation occurs in accordance with certain embodiments of this disclosure;

FIG. 8 depicts a schematic block diagram illustrating additional elements or embodiments of the example device that can implement the OnDrain upgrade strategy to defer application upgrades until a drain operation occurs in accordance with certain embodiments of this disclosure;

FIG. 9 illustrates an example method that can implement the OnDrain upgrade strategy to defer application upgrades until a drain operation occurs in accordance with certain embodiments of this disclosure;

FIG. 10 illustrates an example method that can provide additional embodiments or elements relating to implementing the OnDrain upgrade strategy in order to defer application upgrades until a drain operation occurs in accordance with certain embodiments of this disclosure;

FIG. 11 illustrates a block diagram of an example distributed file storage system that employs tiered cloud storage in accordance with certain embodiments of this disclosure; and

FIG. 12 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

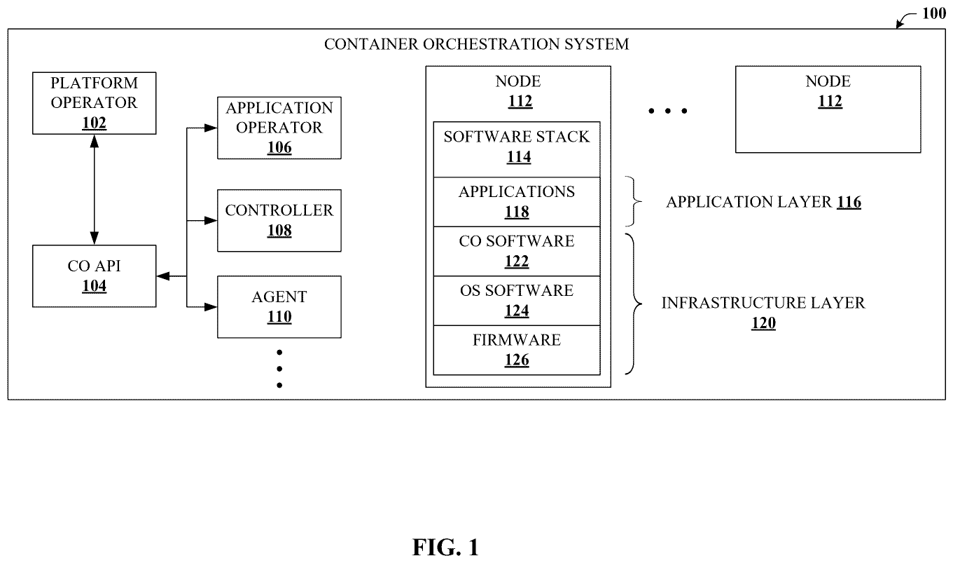

To provide additional context, consider FIG. 1. FIG. 1 shows a schematic block diagram illustrating an example container orchestration (CO) system having various elements that can be leveraged to upgrade a software stack of a node in accordance with certain embodiments of this disclosure. For example, CO system 100 can represent a container orchestration platform cluster or the like comprising multiple nodes 112. As a representative example used for the remainder of this document, CO system 100 is presented in the context (e.g., operation and nomenclature) of a Kubernetes system, which is, today, the most widely used enterprise container orchestration system or platform. However, it is appreciated that the disclosed techniques can be applied to any suitable container orchestration platform, which may have different functional approaches or use different nomenclature to refer to similar functional elements. That is, the disclosed techniques can be suitably applied to any container orchestration platform or another platform that implements the functional element detailed herein such as having node-bound workflows.

In that regard, CO system 100 can be responsible for managing multiple nodes 112, containerized workloads (e.g., applications 118), and associated services. CO system 100 can provide a platform for automating the deployment, scaling, and operation of application containers across clusters of hosts.

As illustrated, CO system 100 can comprise platform operator 102. Platform operator 102 can represent a specialized management component (e.g., often part of an overall “operator” framework) that controls cluster-wide or “platform-level” operations. Platform operator 102 responsibilities typically include initiating and coordinating infrastructure layer 120 elements such as operating system (OS) upgrades (e.g., OS software 124), Kubernetes component upgrades (e.g., CO software 122), and firmware 126 updates on the nodes 112. Platform operator 102 can interact heavily with lower-level scripts or services to drive these system-wide changes.

CO application programming interface (API) 104 (e.g., a Kubernetes API) can represent a standard application programming interface offered by the CO System 100. Hence, CO API 104 can be the main interaction point for automated tools, operators, and administrators to perform actions such as scheduling workloads, updating configurations, and querying cluster state.

Application operator 106 can represent a high-level operator dedicated to managing specific applications 118 running on the CO System 100. Application operator 106 can orchestrate application-centric tasks such as rolling out new container images, defining versioning policies, and controlling any application-specific upgrade strategy (e.g., parallel, rolling). Generally, application operator 106 focuses is on the application layer 116 rather than the underlying infrastructure (e.g., infrastructure layer 120).

Controller 108 (e.g., a Kubernetes controller) and agent 110 (e.g., a kubelet) can assist in executing updates on node 112. For example, a Kubernetes “controller” (e.g., StatefulSet, ReplicaSet, or Deployment controller) can monitor the desired state of workloads and ensures that the running state matches the specifications. For example, when an update is declared for an application 118, controller 108 can determine how pods should be upgraded (e.g., sequentially, in parallel, . . . ) according to the chosen upgrade strategy.

Agent 110 can be a local or cluster-wide agent that helps facilitate upgrades on each node 112. Agent 110 may perform tasks such as checking the node's health, applying OS-level updates, orchestrating package installations, or providing telemetry data back to the platform operator. Agent 110 can often be relied on for performing the actual steps of an upgrade and verifying success or failure.

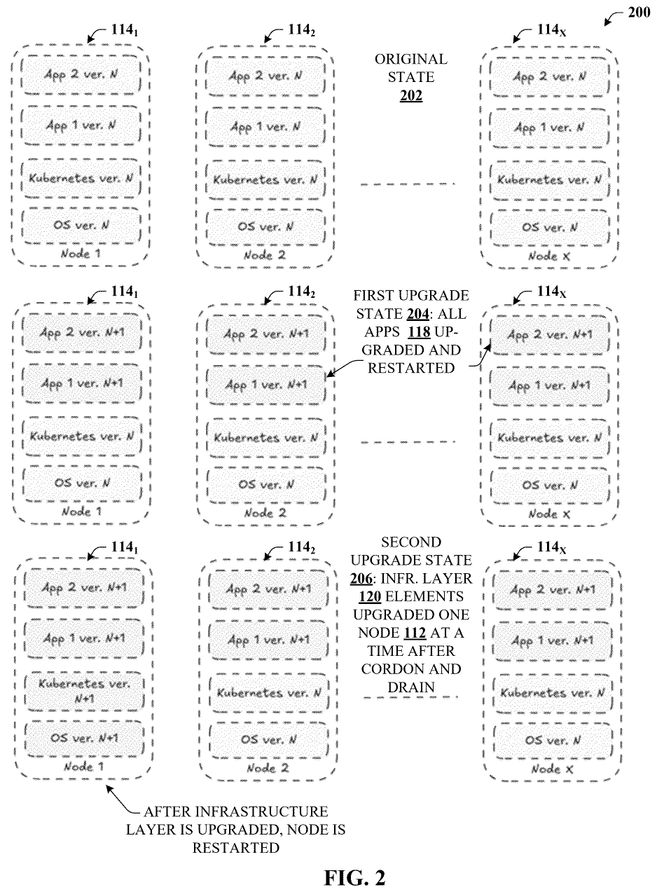

Node 112 can be a physical or virtual machine within the cluster that runs containerized workloads and/or applications 118. Each node 112 can include the resource capacity (e.g., CPU, memory, storage) for hosting pods and provides communication with other nodes 112 in the cluster. Hence, node 112 can be the target for the upgrades illustrated in FIG. 2, and more particularly software stack 114.

Software stack 114 can represent a full set of software components that run on a given node 112. This encompasses both application-level software, namely applications 118 (e.g., containers) that are considered part of application layer 116, and the underlying infrastructure software that is considered part of infrastructure layer 120, e.g., CO software 122 (e.g., Kubernetes), OS software 124, firmware 126, or the like. Managing and upgrading this entire stack can be central to the cluster's overall reliability and performance.

In more detail, applications 118 can represent individual containerized workloads. These might be microservices, data processing jobs, databases, or other modules that together form a complete service offering. Each application 118 typically runs inside one or more pods managed by the CO System 100. CO software 122 can comprise components specific to the container orchestration platform (e.g., Kubernetes services, kubelet, kube-proxy, control plane components). These can ensure that containers are scheduled and managed across the cluster. OS software 124 can represent the base operating system installed on node 112. OS software 124 can manage hardware resources, file systems, networking, and security policies for all higher-layer components, including containers and orchestration tools. Likewise, firmware 126 can represent low-level software that controls the hardware of node 112, such as BIOS or UEFI firmware. Upgrading firmware can be useful to ensure hardware compatibility, security patching, or performance improvements.

In traditional operations, updates to each portion of the software stack 114 (e.g., the application layer 116 and then the infrastructure layer 120) often cause multiple restarts of the same application 118 and/or associated pods. Such is referred to herein as a full software stack upgrade, an entire software stack upgrade, or similar. As used herein, a full software stack upgrade is intended to mean any upgrade process that upgrades at least a portion of elements of the application layer 116 (e.g., at least a portion one or more applications 118) and at least a portion of infrastructure layer 120 (e.g., at least a portion of one or more of CO software 122, OS software 124, firmware 126, . . . ). An example of a full software upgrade is illustrated in connection with FIG. 2

While still referring to FIG. 1, but turning now as well to FIG. 2, depicted is a schematic block diagram 200 illustrating a full software stack upgrade in accordance with certain embodiments of this disclosure. In this example, all applications 118 (e.g., “App 1”, “App2”, . . . ) and both CO software 122 (e.g., “Kubernetes”) and OS software 124 are to be upgraded. Thus, as shown in the original state 202, all such elements currently exist as version N and are to be updated to version N+1. Original state 202 shows the associated states of software stacks 114₁−114_{X}for each respective node 112 of the cluster that is labeled Node 1−Node X.

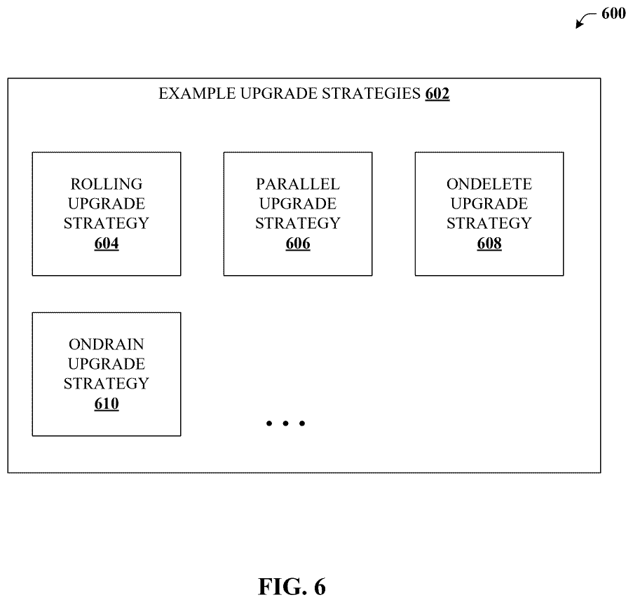

Initially, application operator 106 can define an upgrade order such as App 2 being upgraded prior to App 1 or vice versa. Application operator 106 can further specify an upgrade strategy and identify new image versions. Typical examples of upgrade strategies can be, e.g., a rolling upgrade strategy, a parallel upgrade strategy, an OnDelete upgrade strategy, or the like, which are further detailed in connection with FIG. 6.

As a result, as shown at first upgrade state 204, all applications 118 on all nodes 112 of the cluster can be upgraded to the new (e.g., N+1) versions. It is appreciated that controller 108 can perform the actual upgrading according to the specified upgrade strategy and the specified upgrade order. Typically, upgrades to applications 118 need not rely on a restart of the associated node 112, however, such does result in a restart of the upgraded applications 118, which takes time and can utilize an appreciable amount of system resources.

On the other hand, while upgrades relating to elements of application layer 116 may not invoke a restart of the node, upgrades to certain elements of infrastructure layer 120 typically do. Hence, when platform operator 102 upgrades an element of infrastructure layer 120, various procedures are customarily relied upon. For example, platform operator 102 can perform a cordon operation that cordons off a given node 112. The cordon operation effectively flags the associated node as being un-schedulable.

Thereafter, platform operator 102 can perform a drain operation, which effectively drains or deletes the associated pods. Subsequently, platform operator 102 can upgrade the associated infrastructure elements 120. As illustrated at second upgrade state 206, the example infrastructure layer 120 elements, namely, Kubernetes and OS, have been upgraded to the N+1 versions on software stack 114₁ of Node 1. The above process can then repeat for other software stacks 114₂−114_{X}, until all nodes 112 of the cluster have been upgraded. It is understood that after upgrading the infrastructure layer 120, the associated node 112 is restarted.

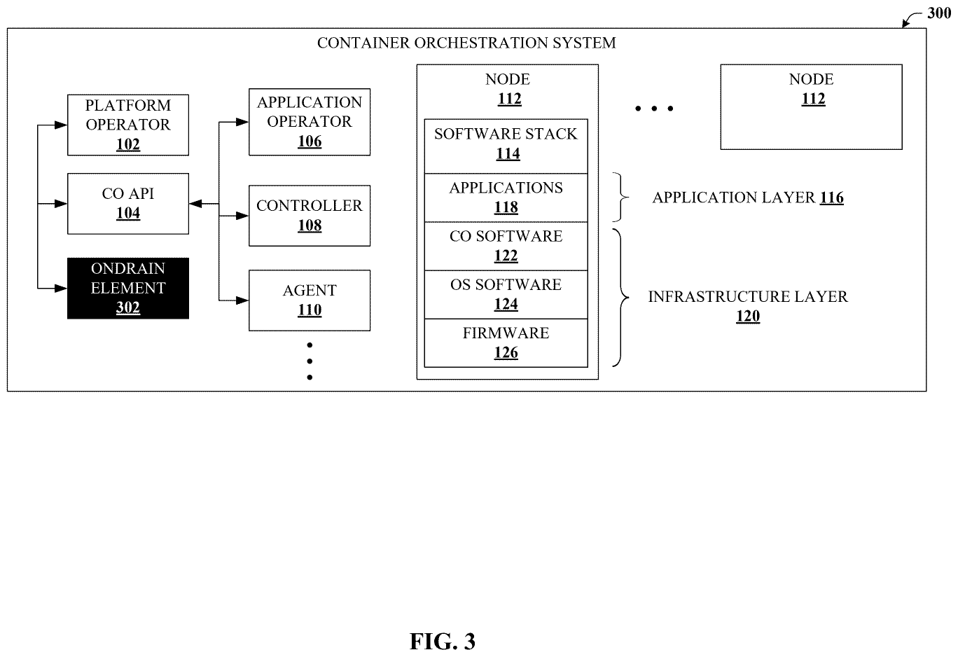

Hence, for a full software stack upgrade, this traditional process results in applications 118 being restarted twice: once when the application version is updated, and again when the node itself is drained and upgraded at the OS/firmware level. Restarting applications 118 during an upgrade process can result in unnecessary downtime or unavailability as well as inefficient use of system resources. The disclosed subject matter is directed in some embodiments to mitigating the above-mentioned issues. For example, the disclosed subject matter can be used to ensure that a full software stack upgrade can be accomplished such that applications 118 restart only once rather than twice, which is further detailed in connection with FIG. 3 and other drawings set forth herein.

### Example Systems

With reference now to FIG. 3, a schematic block diagram is depicted illustrating an example CO system 300 comprising OnDrain element 302 that can be implemented to, e.g., defer the customer upgrade of applications 118 until a drain operation is detected in accordance with certain embodiments of this disclosure. CO system 300 can be similar to previous CO system 100, but can be extended to allow the disclosed techniques in ways that will become apparent in this disclosure.

Because existing CO systems 100 do not presently have this capability, existing CO systems 100 can thus be modified accordingly to include OnDrain element 302, such as CO system 300. Such modifications can relate to adding new or improved elements to one or more of CO API 104 (e.g., to enable OnDrain calls or the like), platform operator 102, or any other suitable component of CO systems 100, 300.

For example, in some embodiments, OnDrain element 302 can represent an extension of application definitions or APIs. Thus, OnDrain can be a recognized upgrade strategy for CO system 300 in the applications resource specification such as a custom resource definition (CRD) or a deployment specification. For instance, in a Kubernetes-like environment, upgradeStrategy: OnDrain can be added to the CRD to describe how to manage stateful workloads.

Further, in some embodiments, OnDrain element 302 can represent a modification to controller logic of controller 108 and/or a customized controller 108, e.g., to recognize upgradeStrategy: OnDrain. Thus, controller 108 can then be configured to listen for node drain events and/or pod eviction events triggered by a node drain operation. For example, controller 108 of CO system 300 can be configured to update a pod's container image to the new version (e.g., N+1) only when the associated node 112 is actually drained, not before such an event.

In some embodiments, OnDrain element 302 can represent an enhancement to platform operator 102. For example, platform operator 102 can be extended to announce when a node is about to be cordoned and drained. Such can utilize a custom event or status field indicating that a particular node 112 drain has started (e.g., annotating node 112 with a custom “drain-in-progress” label or the like). As noted, when platform operator 102 decides to upgrade some infrastructure layer 120 element, the associated node 112 is cordoned and drained. The associated drain operation can trigger the Ondrain logic in the application controller, thus ensuring that the application's pod is upgraded once and only during the node drain operation.

In some embodiments, OnDrain element 302 can represent a modification or enhancement to agent 110, which can relate to, e.g., draining hooks, status reporting and so on. For instance, in some cases, a small hook or script can be added to agent 110 (e.g., a kublet) that signals the OnDrain controller whenever a pod eviction is requested. Such can be implemented as an event to the controller 108 whenever node 112 transitions from unschedulable or whenever a pod is force-evicted. Agent 110 can be configured to report additional status or metrics to the OnDrain controller 108, confirming that pods are terminated so the application can be updated at the time of platform upgrades.

Hence, the OnDrain strategy in place, controller 108 can defer upgrading a pod's container image until the node 112 hosting that pod is explicitly drained. When the platform operator 102 cordons (e.g., marks the node unschedulable) and then drains the node (e.g., evicts or terminates all pods), only then does controller 108 and application operator 106 upgrade the corresponding pod's container image

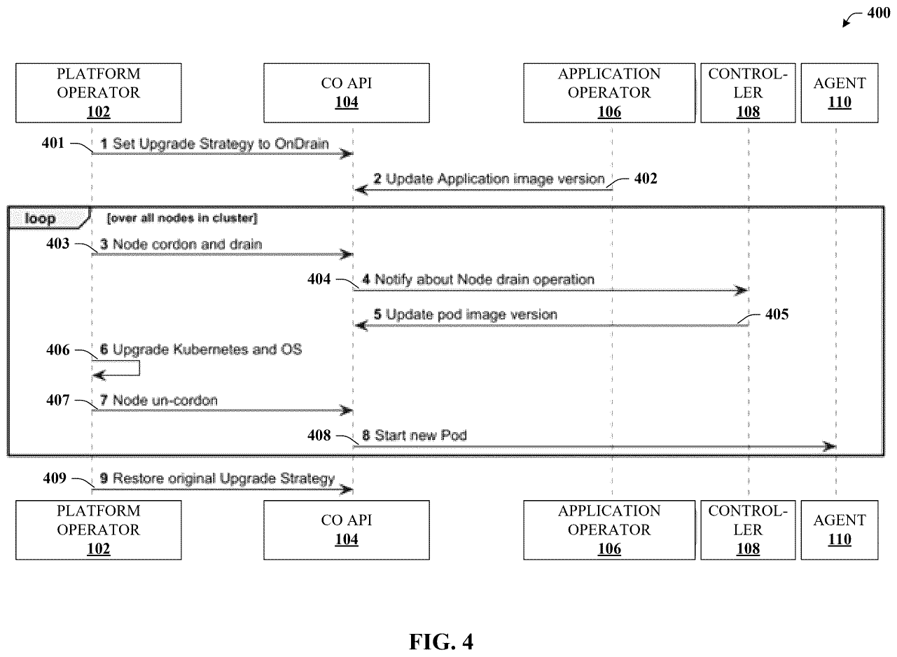

Referring now to FIG. 4, an example call flow diagram 400 is depicted illustrating an example call flow for a full software stack upgrade using the OnDrain strategy in accordance with certain embodiments of this disclosure. For example, upon a determination that a pending software stack upgrade is a full software stack upgrade, platform operator 102 can issue instructions to set the upgrade strategy to OnDrain, as shown at reference numeral 401.

As part of the upgrade, application operator 106 can issue a call to update application image versions, as illustrated at reference numeral 402. Thereafter, the following group of instructions/calls can be looped in an iterative fashion for each node 112 of a cluster. For example, at reference numeral 403, platform operator 102 can send a call for a node to be cordoned and drained. At reference numeral 404, CO API 104, in response to 403, can notify controller 108 regarding the OnDrain strategy. Thus, controller 108 can be configured to watch for a node drain operation on nodes 112 where application pods are currently running, but otherwise to refrain from executing application upgrades as per the OnDrain strategy. Controller 108 can be configured to update pod image versions, as indicated at reference numeral 405.

At reference numeral 406, platform operator 102 can cordon and drain node 112 in order to upgrade infrastructure layer 120 elements (e.g., Kubernetes, OS, . . . ), which can also trigger application 118 upgrades. At reference numeral 407, platform operator 102 can un-cordon node 112 and the node can restart. In response, at reference numeral 408, CO API 104 can start the new pod. It is noted that in this case, the pod only restarts a single time. The loop/iteration portion can repeat for each node 112 in the cluster. After the loop/iteration process completes, at reference numeral 409, platform operator 102 can restore the original upgrade strategy.

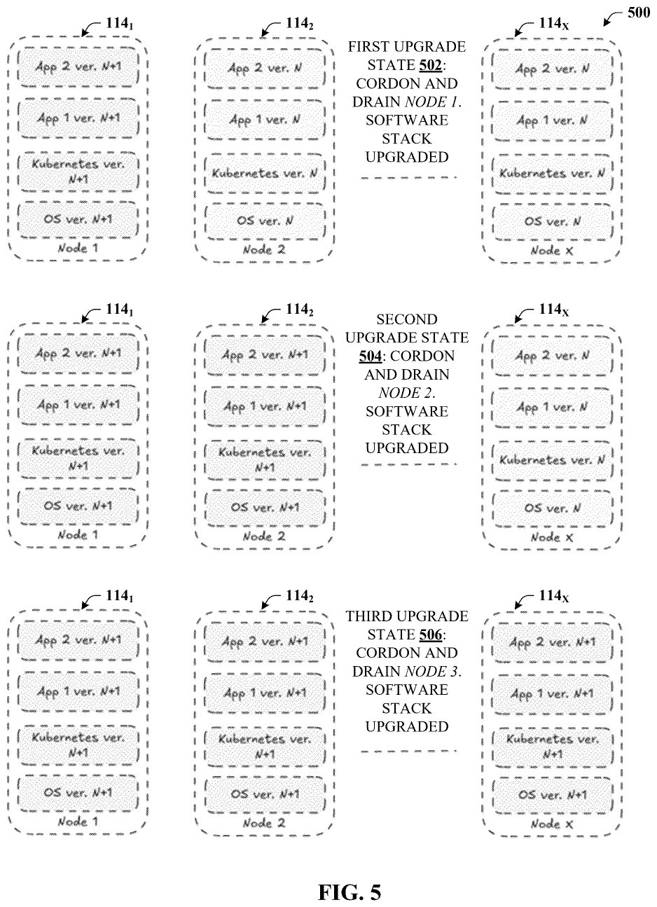

Now referencing FIG. 5, depicted is a schematic diagram illustrating a full software stack upgrade that implements the OnDrain strategy in accordance with certain embodiments of this disclosure. For example, the OnDrain strategy can be implemented by CO system 300 that comprises OnDrain element(s) 302 detailed in connection with FIGS. 3 and 4.

While not expressly shown here, it is assumed that all nodes 112 start in original state 202, as indicated at FIG. 2. As per original state 202, all applications 118 on all nodes 112 of the cluster have initial version, N, which are to be upgraded to the new (e.g., N+1) version. Further, all infrastructure layer 120 items (e.g., CO software 122, OS software 124, . . . ) are to be upgraded from the N to the N+1 version.

Again, application operator 106 can define an upgrade order such as App 2 being upgraded prior to App 1 or vice versa. Platform operator 102 or other elements of CO system 300 can further set the upgrade strategy to OnDrain. Such can be invoked, for example, in response to a determination that a given software upgrade is a full stack upgrade in which at least one application layer 116 element is to be upgraded and at least one infrastructure layer 120 element is to be upgraded during the software upgrade. Hence, in those cases, the upgrade strategy can be changed from a current upgrade strategy to the OnDrain strategy. As introduced above, typical examples of current or existing upgrade strategies can be, e.g., a rolling upgrade strategy, a parallel upgrade strategy, an OnDelete upgrade strategy, or the like, which are further detailed in connection with FIG. 6.

As a result, as shown at first upgrade state 502, all applications 118 on Node 1 can be upgraded to the new (e.g., N+1) versions. Likewise, all infrastructure layer 120 elements can also be upgraded. Because applications 118 are deferred and/or until after Node 1 has been cordoned and drained, all upgrades are performed in a single pass without restarting applications 118 more than once, when Node 1 itself restarts.

This process, an example of which was detailed in connection with FIG. 4, can be iteratively applied on a node-by-node basis. Hence, at second upgrade state 504, Node 2 is condoned and drained and the associated software stack 114₂ on that node 112 is upgraded in a single pass. In turn, at third upgrade state 506, Node X is condoned and drained and the associated software stack 114_{X} on that node 112 is upgraded in a single pass, so that all nodes 112 on the cluster have been upgraded according to the OnDrain Strategy.

Turning now to FIG. 6, a schematic block diagram 600 is depicted illustrating various examples of upgrade strategies 602 that can be defined by the CO system 300 in accordance with certain embodiments of this disclosure.

Rolling upgrade strategy 604 generally proceeds by updating the application replicas one at a time (or in small batches). In a Kubernetes context, controllers such as StatefulSet, ReplicaSet, or Deployment typically use rolling upgrade strategy 604 as the default strategy to ensure minimal disruption. Thus, only one (or a few) pod is stopped and upgraded at a time. While that pod is being upgraded, the remaining pods continue running the old version to ensure continuous service availability. Such can result in better service continuity with minimal downtime and more graceful rollback properties if an issue is discovered with the new version prior to completing the upgrade of all replicas. However, rolling upgrade strategy 604 is typically more time-consuming, and during the upgrade, each pod may end of restarting more than once.

Parallel upgrade strategy 606 upgrades all replicas at the same time. For example, all pods are brought down, new images are pulled, and the pods come back up with the updated version in one operation. Parallel upgrade strategy 606 can be simpler and can significantly shorten the total upgrade window. However, there is a higher chance of service disruption when all replicas go down simultaneously, and rollback can be less graceful should issues appear with the newer version. Further, when using parallel upgrade strategy 606, each pod may end of restarting more than once.

OnDelete upgrade strategy 608 is a Kubernetes-provided strategy in which the upgrade takes effect only when a pod is manually deleted. This contrasts with rolling upgrade strategy 604 or parallel upgrade strategy 606, which automatically control pod restarts based on a set update strategy. Generally, an operator or external system must explicitly delete a pod for the upgraded version to come into effect. When the pod is deleted, the controller 108 notices the discrepancy between the current state and desired state (e.g., new image version) and then recreates the pod with the upgraded image. However, various issues can arise when using OnDelete upgrade strategy 608 such as unexpected triggering and no guarantee for upgrade order. For example, if a node or its kubelet restarts, pods can be evicted or deleted unexpectedly, causing the upgrade to proceed automatically and potentially out of order. Because any external event that causes a pod deletion triggers an upgrade, controlling the sequence of upgrades at scale can be problematic.

OnDrain upgrade strategy 610 represents the newly proposed strategy to reduce overall upgrade time and minimize disruptions for node-bound (often stateful) workloads. OnDrain upgrade strategy 610 can be utilized in connection with full software stack upgrades. OnDrain upgrade strategy 610 differs from strategies 604 and 606 in that OnDrain upgrade strategy 610 can ensure that pods are restarted only once during the upgrade. OnDrain upgrade strategy 610 differs from OnDelete upgrade strategy 608 in that OnDrain upgrade strategy 610 can wait specifically for a node drain event before upgrading pods on that node and further can preserve upgrade order.

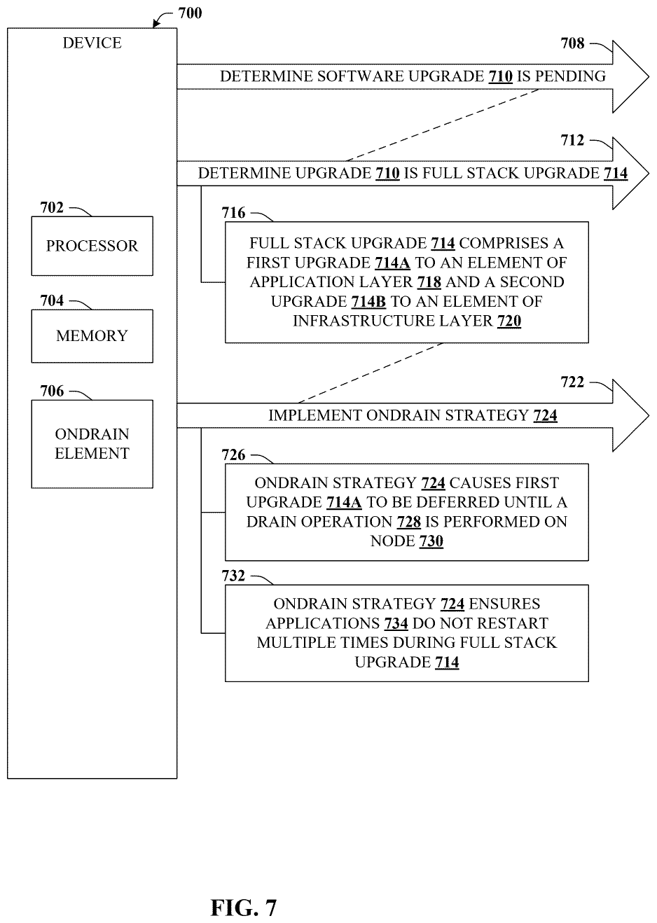

With reference now to FIG. 7, a schematic block diagram illustrating an example device 700 that can implement an OnDrain strategy 724 to defer application upgrades until a drain operation occurs in accordance with certain embodiments of this disclosure. In that regard, device 700 can, in some embodiments, be integrated into an orchestration system such as CO system 300, which can be, e.g., a Kubernetes system or another suitable container orchestration platform.

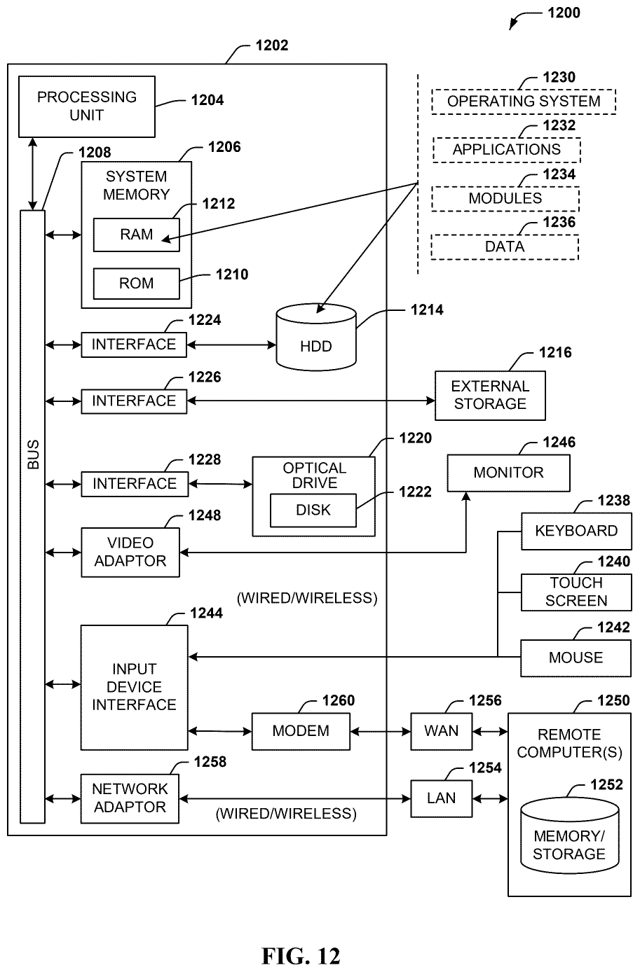

Device 700 can comprise at least one processor 702 that, potentially along with health test device 706, can be specifically configured to perform functions associated with initiating volume health tests via a container orchestration platform. Device 700 can also comprise at least one memory 704 that stores executable instructions that, when executed by the at least one processor 702, can facilitate performance of operations. Processor(s) 702 can be a hardware processor having structural elements known to exist in connection with processing units or circuits, with various operations of processor 702 being represented by functional elements shown in the drawings herein that can require special-purpose instructions, for example, stored in memory 704 and/or OnDrain element 706 (e.g., onDrain element 302). Along with these special-purpose instructions, processor 702 and/or OnDrain element 706 can be a special-purpose device. Further examples of the memory 704 and processor 702 can be found with reference to FIG. 12. It is to be appreciated that device 700 or computer 1102 can represent a server device or a client device of a container orchestration services platform and computer 1202 can be used in connection with implementing one or more of the systems, devices, or components shown and described in connection with FIG. 7 and other figures disclosed herein.

As illustrated at reference numeral 708, device 700 can determine that software upgrade 710 is pending. At reference numeral 712, by examining certain elements of software upgrade 710 and/or associated data, device 700 can determine that software upgrade 710 is a full stack upgrade 714. As illustrated at reference numeral 716, full stack upgrade 714 can comprise a first upgrade 714A to an element of application layer 718 (e.g., application layer 116) and a second upgrade 714B to an element of infrastructure layer 720 (e.g., infrastructure layer 120). In other words, in response to a determination that a software upgrade 710 is to be performed upon a node 730 (e.g., node 112) of a CO platform (e.g., CO system 300), determining that the software upgrade 710 is a full stack upgrade 714, wherein the full stack upgrade 714 comprising a first upgrade 714A of applications 734 (e.g., applications 118) deployed on the node 730 and a second upgrade 714B of a CO infrastructure element deployed on the node 730 such as e.g., CO software 122, OS software 124, firmware 126, and so on.

At reference numeral 722, in the case of a full stack upgrade 714, device 700 can implement OnDrain strategy 724 (e.g., OnDrain upgrade strategy 610). In some embodiments, in situations where software upgrade 710 is not a full stack upgrade 714, then OnDrain strategy 724 need not be implemented. In some embodiments, OnDrain strategy 724 can cause a platform operator 102 of the CO platform to set the OnDrain strategy 724. As illustrated at reference numerals 726 and 732, and detailed herein, OnDrain strategy 724 can cause first upgrade 714A (e.g., the portion relating to applications 734) to be deferred until drain operation 728 is performed on node 730. Thus, OnDrain strategy 724 can ensure applications 734 do not restart multiple times during full stack upgrade 714.

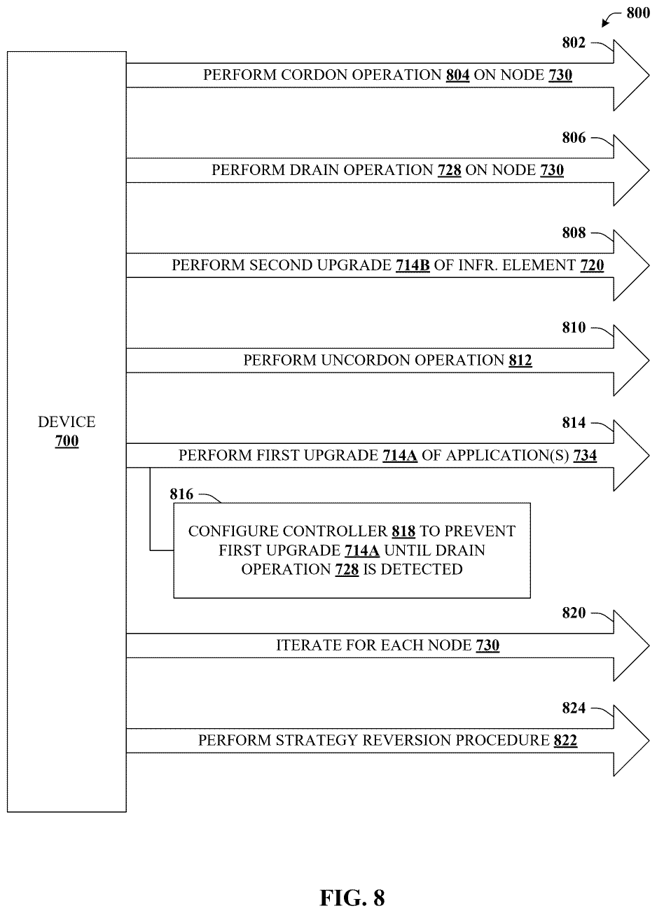

Turning now to FIG. 8, a schematic block diagram 800 illustrating additional elements or embodiments of the example device 700 that can implement the OnDrain strategy 724 to defer application upgrades until a drain operation occurs in accordance with certain embodiments of this disclosure.

For example, at reference numeral 802, device 700 can perform (e.g., via the platform operator 102) cordon operation 804 on node 730. Cordon operation 804 can cause node 730 to become unschedulable. At reference numeral 806, device 700 can perform (e.g., via the platform operator 102) drain operation 728. Drain operation 728 can cause containers (e.g., pods or applications 734) to be deleted.

At reference numeral 808, device 700 can perform second upgrade 714B of infrastructure elements 720 (e.g., of CO software 122, OS software 124, firmware 126, . . . ). At reference numeral 810, subsequent to upgrade 714B, device 700 can perform (e.g., via platform operator 102) uncordon operation 812, causing node 730 to again become schedulable.

However, in response to drain operation 728 detailed in connection with reference numeral 806, device 700 can perform upgrade 714A of applications 734 for the associated node 730. Such can occur either before or after second upgrade 714B, and will typically occur sometime between drain operation 728 and uncordon operation 812. Upgrade 714A will not be performed sooner because, as shown at reference numeral 816, controller 818 (e.g., controller 108) can be configured to prevent first upgrade 714A until drain operation 728 is detected.

At reference numeral 820, device 700 can cause full upgrade 714 to be iterated on each node 730 or a cluster. At reference numeral 824, in response to full stack upgrade 714 being completed on node 730 and/or all nodes 730 of a cluster, device 700 can perform strategy reversion procedure 822. Strategy reversion procedure 822 can operator to return the upgrade strategy to whatever setting was previously configured (e.g., rolling upgrade strategy 604, parallel upgrade strategy 606, . . . ) prior to changing such to OnDrain strategy 724 in response to full stack upgrade 714 being determined to be pending.

### Example Methods

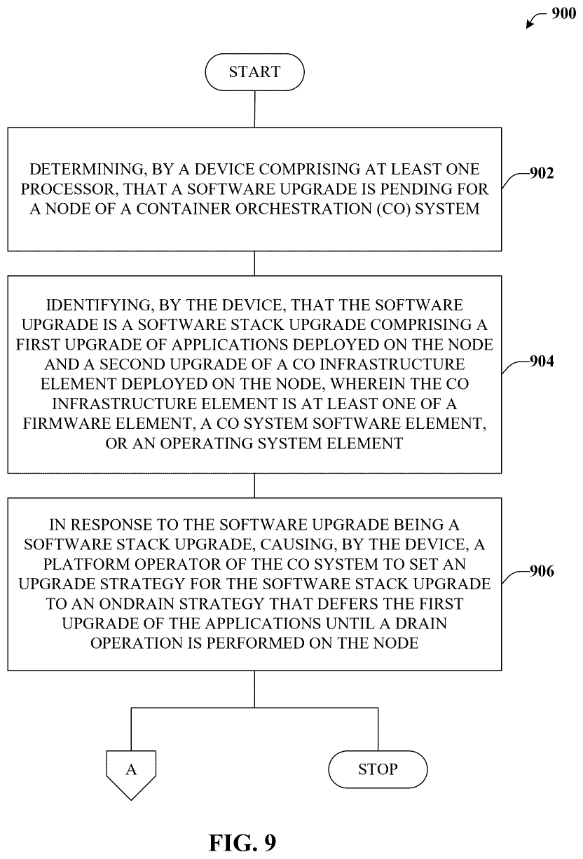

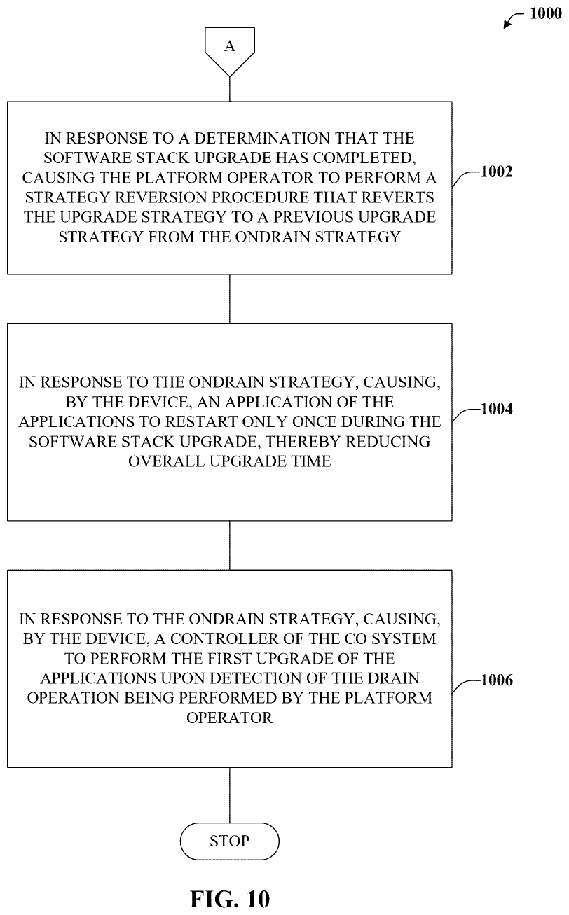

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 9, exemplary method 900 is depicted. Method 900 that can implement the OnDrain upgrade strategy to defer application upgrades until a drain operation occurs in accordance with certain embodiments of this disclosure. While method 900 describes a complete method, in some embodiments, method 900 can include one or more elements of method 1000, as illustrated by insert A.

At reference numeral 902, a device comprising at least one processor can determine that a software upgrade is pending for a node of a CO system. In response to such a determination, at reference numeral 904, the device can identify that the software upgrade is a software stack upgrade (e.g., a full or entire software stack upgrade). The (e.g., full) software stack upgrade can be one that comprises both a first upgrade of applications deployed on the node and a second upgrade of a CO infrastructure element deployed on the node. The CO infrastructure element can be at least one of a firmware element, a CO system software element (e.g., Kubernetes software), or an operating system software element.

At reference numeral 906, in response to the software upgrade being a software stack upgrade, causing, by the device, a platform operator of the CO system to set an upgrade strategy for the software stack upgrade to an OnDrain strategy. The OnDrain strategy can be one that defers the first upgrade of the applications until a drain operation is performed on the node. The drain operation can be performed in response to the execution of the second upgrade of the CO infrastructure element. Method 900 can terminate or continue to insert A, which is further detailed in connection with FIG. 10.

Turning now to FIG. 10, exemplary method 1000 is depicted. Method 1000 can provide additional embodiments or elements relating to implementing the OnDrain upgrade strategy in order to defer application upgrades until a drain operation occurs in accordance with certain embodiments of this disclosure.

At reference numeral 1002, the device introduced at reference numeral 902 comprising at least one processor can, in response to a determination that the software stack upgrade has completed, cause the platform operator to perform a strategy reversion procedure that reverts the upgrade strategy to a previous upgrade strategy from the OnDrain strategy.

At reference numeral 1004, the device can, in response to the OnDrain strategy, cause an application of the applications to restart only once during the software stack upgrade, thereby reducing overall upgrade time.

At reference numeral 1006, the device can, in response to the OnDrain strategy, cause a controller of the CO system to perform the first upgrade of the applications upon detection of the drain operation being performed by the platform operator.

### Example Operating Environments

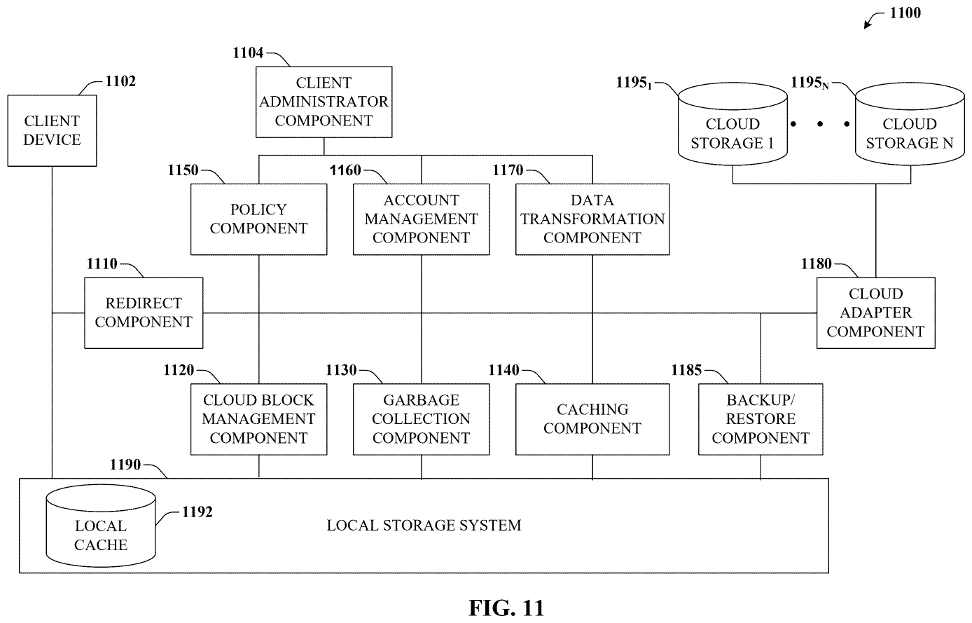

To provide further context for various aspects of the subject specification, FIGS. 11 and 12 illustrate, respectively, a block diagram of an example distributed file storage system 1100 that employs tiered cloud storage and block diagram of a computer 1202 operable to execute the disclosed storage architecture in accordance with aspects described herein.

Referring now to FIG. 11, there is illustrated an example local storage system including cloud tiering components and a cloud storage location in accordance with implementations of this disclosure. Client device 1102 can access local storage system 1190. Local storage system 1190 can be a node and cluster storage system such as an EMC Isilon Cluster that operates under OneFS operating system. Local storage system 1190 can also store the local cache 1192 for access by other components. It can be appreciated that the systems and methods described herein can run in tandem with other local storage systems as well.

As more fully described below with respect to redirect component 1110, redirect component 1110 can intercept operations directed to stub files. Cloud block management component 1120, garbage collection component 1130, and caching component 1140 may also be in communication with local storage system 1190 directly as depicted in FIG. 11 or through redirect component 1110. A client administrator component 1104 may use an interface to access the policy component 1150 and the account management component 1160 for operations as more fully described below with respect to these components. Data transformation component 1170 can operate to provide encryption and compression to files tiered to cloud storage. Cloud adapter component 1180 can be in communication with cloud storage 1 1195₁ and cloud storage N 1195_{N}, where N is a positive integer. It can be appreciated that multiple cloud storage locations can be used for storage including multiple accounts within a single cloud storage location as more fully described in implementations of this disclosure. Further, a backup/restore component 1185 can be utilized to back up the files stored within the local storage system 1190.

Cloud block management component 1120 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1120 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1160 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1120 based on list of mappings it manages. For example, each stub can be associated with an account, and the cloud block management component 1120 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1180 manages the sending and receiving of data to and from the cloud service providers. The cloud adapter component 1180 can utilize a set of APIs. For example, each cloud service provider may have provider specific API to interact with the provider.

A policy component 1150 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1130. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1130 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1140 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1120, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1140 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1140 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1170 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1185 can transfer a copy of the files within the local storage system 1190 to another cluster (e.g., target cluster). Further, the backup/restore component 1185 can manage synchronization between the local storage system 1190 and the other cluster, such that, the other cluster is timely updated with new and/or modified content within the local storage system 1190.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the . NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1202.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11 a) data rate, and/or a 2.4 GHz radio band at an 12 Mbps (802.11 b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to a determination that a software upgrade is to be performed upon a node of a container orchestration (CO) platform, determining that the software upgrade is a software stack upgrade comprising a first upgrade of applications deployed on the node and a second upgrade of a CO infrastructure element deployed on the node; and
in response to the software upgrade being a software stack upgrade, causing a platform operator of the CO platform to set an upgrade strategy for the software stack upgrade to an OnDrain strategy that defers the first upgrade of the applications until a drain operation is performed on the node.

2. The device of claim 1, wherein the CO infrastructure element is at least one of firmware, CO platform software, operating system software, or another element that, upon upgrade, relies on a restart of the node.

3. The device of claim 1, wherein the OnDrain strategy causes an application of the applications to restart only once during the software stack upgrade, thereby reducing overall upgrade time.

4. The device of claim 1, wherein the OnDrain strategy preserves an upgrade order that is determined by an application operator, and wherein the upgrade order specifies an order of upgrade for the applications.

5. The device of claim 1, wherein the operations further comprise, in response to the OnDrain strategy, the platform operator is configured to:
perform a cordon operation on the node, causing the node to become un-schedulable;
perform the drain operation on the node, causing containers of the node to be deleted;
perform the second upgrade of the infrastructure element; and
perform an uncordon operation on the node, causing the node to become schedulable.

6. The device of claim 5, wherein the platform operator is further configured to:
monitor a progress of the software stack upgrade;
perform error handling and rollback if the drain operation or the software stack upgrade enters a failure state; and
resume the software stack upgrade once the node returns to an operational state.

7. The device of claim 1, wherein the operations further comprise, in response to the OnDrain strategy, a controller of the CO platform is configured to:
defer the first upgrade until the drain operation is performed; and
in response to the drain operation being performed by the platform operator, performing the first upgrade of the applications.

8. The device of claim 1, wherein the operations further comprise, in response to a determination that the software stack upgrade has completed, causing the platform operator to perform a strategy reversion procedure that reverts the upgrade strategy to a previous upgrade strategy from the OnDrain strategy.

9. The device of claim 8, wherein the previous upgrade strategy is at least one of a rolling strategy that upgrades an application of the applications replica by replica or a parallel strategy that upgrades each replica of the application concurrently.

10. The device of claim 1, wherein the operations further comprise iteratively performing the software stack upgrade in sequence on other nodes, other than the node, of the CO platform.

11. A device, comprising:
at least one processor; and
at least one memory that stores executable instructions that, when executed by the at least one processor, facilitate performance of operations, comprising:
in response to a determination that a software upgrade is to be performed upon node of a container orchestration (CO) platform, determining that the software upgrade is a software stack upgrade comprising a first upgrade of applications deployed on the node and a second upgrade of a CO infrastructure element deployed on the node;
in response to the software upgrade being a software stack upgrade, causing a platform operator of the CO platform to set an upgrade strategy for the software stack upgrade to an OnDrain strategy that defers the first upgrade of the applications until a drain operation is performed on the node;
in response to the OnDrain strategy, the platform operator is configured to:
perform a cordon operation on the node, causing the node to become un-schedulable;
perform the drain operation on the node, causing containers of the node to be deleted;
perform the second upgrade of the infrastructure element; and
perform an uncordon operation on the node, causing the node to become schedulable; and
in response to the OnDrain strategy, a controller of the CO platform is configured to perform the first upgrade of the applications upon detection of the drain operation being performed by the platform operator.

12. The device of claim 11, wherein the CO infrastructure element is at least one of firmware, CO platform software, operating system software, or another element that, upon upgrade, relies on a restart of the node.

13. The device of claim 11, wherein the OnDrain strategy causes an application of the applications to restart only once during the software stack upgrade, thereby reducing overall upgrade time.

14. The device of claim 11, wherein the OnDrain strategy maintains an upgrade order that is determined by an application operator, and wherein the upgrade order specifies an order of upgrade for the applications.

15. The device of claim 11, wherein the operations further comprise, in response to a determination that the software stack upgrade has completed, causing the platform operator to perform a strategy reversion procedure that reverts the upgrade strategy to a previous upgrade strategy from the OnDrain strategy.

16. The device of claim 11, wherein the operations further comprise iteratively performing the software stack upgrade in sequence on other nodes, other than the node, of the CO platform.

17. A method, comprising:
determining, by a device comprising at least one processor, that a software upgrade is pending for a node of a container orchestration (CO) system;
identifying, by the device, that the software upgrade is a software stack upgrade comprising a first upgrade of applications deployed on the node and a second upgrade of a CO infrastructure element deployed on the node, wherein the CO infrastructure element is at least one of a firmware element, a CO system software element, or an operating system element; and
in response to the software upgrade being a software stack upgrade, causing, by the device, a platform operator of the CO system to set an upgrade strategy for the software stack upgrade to an OnDrain strategy that defers the first upgrade of the applications until a drain operation is performed on the node.

18. The method of claim 17, further comprising, in response to a determination that the software stack upgrade has completed, causing the platform operator to perform a strategy reversion procedure that reverts the upgrade strategy to a previous upgrade strategy from the OnDrain strategy.

19. The method of claim 17, further comprising, in response to the OnDrain strategy, causing, by the device, an application of the applications to restart only once during the software stack upgrade, thereby reducing overall upgrade time.

20. The method of claim 17, further comprising, in response to the OnDrain strategy, causing, by the device, a controller of the CO system to perform the first upgrade of the applications upon detection of the drain operation being performed by the platform operator.
